(19) United States
(12) Patent Application Publication
(10) Pub. No.: US 2016/0070088 A1
(43) Pub. Date: Mar. 10, 2016

(54) IMAGING APPARATUS HAVING BENDING OPTICAL ELEMENT

(71) Applicant: HOYA CORPORATION, Tokyo (JP)

(72) Inventor: Mutsumi KOGUCHI, Saitama (JP)

(73) Assignee: HOYA CORPORATION, Tokyo (JP)

(21) Appl. No.: 14/828,883

(22) Filed: Aug. 18, 2015

(30) Foreign Application Priority Data
Sep. 10, 2014 (JP) 2014-183793

(51) Int. Cl. G02B 13/00; G02B 7/10; G02B 15/20

(52) U.S. Cl. CPC G02B 13/0065; G02B 15/20; G02B 13/009; G02B 7/102

(57) ABSTRACT

A bending imaging apparatus includes a movable lens group, a motor which drives the movable lens group and includes a lead screw extending parallel to the optical axis, a bending optical element at at least one end of the optical axis, a housing which supports the movable lens group and the bending optical element; a motor support bracket including a motor support portion, a screw support portion, and a planar portion between the motor support portion and the screw support portion and extends alongside the housing; a cover member including a planar portion facing the planar portion of the motor support bracket, and a fixer which fixes the cover member to the housing with a repulsive force generated between the planar portions of the motor support bracket and the cover member with the motor support bracket pressed against the housing.

### BACKGROUND OF THE INVENTION

1. Field of the Invention

The present invention relates to a motor-driven imaging apparatus having at least one bending optical element.

2. Description of the Related Art

In recent years, mobile electronic devices which are designed mainly for taking still/moving photographic images, such as digital cameras (still-video cameras) and digital camcorders (video cameras), and other mobile electronic devices which are designed to be capable of taking such photographic images as a subsidiary function, such as mobile phones equipped with a camera and smart devices (e.g., smart phones and tablet computers), etc., equipped with a camera, have become widespread, and there has been a demand to miniaturize the imaging unit incorporated in these types of mobile electronic devices. In order to miniaturize an imaging unit, it is known to configure the imaging optical system of an imaging unit as a bending optical system which reflects (bends) an object light bundle (object-emanating light) using a reflection surface of a reflecting element (bending optical element) such as a prism or a mirror, and to make an image sensor receive the object light bundle which emanates from the imaging optical system. An imaging optical system having at least one bending optical element (hereinafter also referred to as the “bending imaging optical system”) is advantageous in achieving a reduction in thickness of the imaging unit in the travelling direction of the incident light emanating from an object to be photographed (Japanese Unexamined Patent Publication Nos. 2006-267391, 2010-243763 and 2013-105049).

In an imaging unit having such a bending imaging optical system (hereinafter also referred to as the “bending imaging apparatus”), an apparatus in which movable lens groups arranged on a post-bending optical axis (the optical axis after being optically bent by a bending optical element) are driven by a pair of motors, each having a lead screw shaft (“screw motors”) has been proposed (Japanese Unexamined Patent Publication No. 2010-20193). In Japanese Unexamined Patent Publication No. 2010-20193, after the pair of screw motors are fixed to two independent retainer plates (“motor support brackets”), respectively, these retainer plates are fixed to a connecting plate (“base plate”) provided independently of the retainer plates, and additionally, this connecting plate is fixed to a housing.

In conventional bending imaging apparatuses having screw motors, a fixing structure using set screws is used to fix the motor support brackets to the base plate and to fix the base plate to the housing. However, in bending imaging apparatuses which have been developed to be miniaturized to the limit, the housing that is made of synthetic resin has been desired to be miniaturized to the limit, specifically in thickness; therefore, according to the aforementioned fixing structure using set screws, it has been proven that the housing is distorted to thereby deteriorate the linearity of the optical axis of the imaging optical system. Additionally, according to the aforementioned fixing structure using set screws, the motor support brackets or the base plate becomes complicated in shape, which causes the possibility of exerting an adverse effect on productivity and ease of assembly.

### SUMMARY OF THE INVENTION

The present invention provides a bending imaging apparatus having at least one bending optical element and at least one screw motor, wherein a motor support bracket to which the screw motor is fixed can be fixed to a housing of the bending imaging apparatus without using set screws.

According to an aspect of the present invention, a bending imaging apparatus is provided, including a movable lens group which is movable along an optical axis thereof; a motor which drives the movable lens group and includes a lead screw extending parallel to the optical axis; a bending optical element arranged at at least one end of the optical axis to bend an object-emanating light bundle; a housing which supports the movable lens group and the bending optical element; a motor support bracket which includes a motor support portion that supports the motor, a screw support portion that supports an end of the lead screw, and a planar portion that is positioned between the motor support portion and the screw support portion and extends alongside the housing; a cover member which includes a planar portion facing the planar portion of the motor support bracket; and a fixer which fixes the cover member to the housing with a repulsive force generated to act between the planar portion of the motor support bracket and the planar portion of the cover member and with the motor support bracket pressed against the housing.

It is desirable for the fixer to include an elastic member which is sandwiched and fixed between the planar portion of the motor support bracket and the planar portion of the cover member.

It is desirable for the bending imaging apparatus to include a positioner which is positioned between the housing and the motor support bracket to position the housing and the motor support bracket with respect to each other.

It is desirable for the cover member to be made of a resilient material, and for the fixer to include a plurality of engaging lugs formed on the cover member to protrude therefrom; and a plurality of engaging portions formed on the housing to be engaged with the plurality of engaging lugs.

It is desirable for an engaging hole to be formed in at least one of the engaging lugs, and for at least one of the engaging portions of the housing to include an engaging projection which is engaged in the engaging hole of the at least one of the engaging lugs.

It is desirable for at least one of the plurality of engaging lugs to include an engaging protrusion, and for at least one of the engaging portions to include an engaging recessed portion in which the engaging protrusion is engaged, the engaging recessed portion being formed on the housing.

It is desirable for the fixer to include a plurality of engaging portions which are integrally formed with the housing to be engageable with the cover member.

It is desirable for the positioner to be integrally formed with the housing.

According to the present invention, the possibility of the housing that supports the movable lens group and the bending optical element being distorted is small, which makes it possible to secure the linearity of the optical axis of the imaging optical system.

The present disclosure relates to subject matter contained in Japanese Patent Application No. 2014-183793 (filed on Sep. 10, 2014) which is expressly incorporated herein by reference in its entirety.

### BRIEF DESCRIPTION OF THE DRAWINGS

The present invention will be described below in detail with reference to the accompanying drawings in which:

FIG. 1 is a perspective view of an embodiment of a bending imaging apparatus according to the present invention, showing the outward appearance thereof;

FIG. 2 is a rear perspective view of the bending imaging apparatus, viewed from the rear side thereof;

FIG. 3 is a rear perspective view of the bending imaging apparatus, viewed from a different direction;

FIG. 4 is a perspective view of the bending imaging apparatus before it is assembled;

FIG. 5 is a perspective view of the housing of the bending imaging apparatus, illustrating the shape of the housing;

FIG. 6 is a perspective view of the internal structure of the bending imaging apparatus;

FIG. 7 is a transverse sectional view of the bending imaging apparatus, taken along a plane including a post-bending optical axis, the optical axis of the movable lens group and the optical axis of the image sensor;

FIG. 8 is a transverse sectional view taken along the line VIII-VIII shown in FIG. 3; and

FIG. 9 is a right side elevational view of the bending imaging apparatus.

### DESCRIPTION OF THE PREFERRED EMBODIMENT

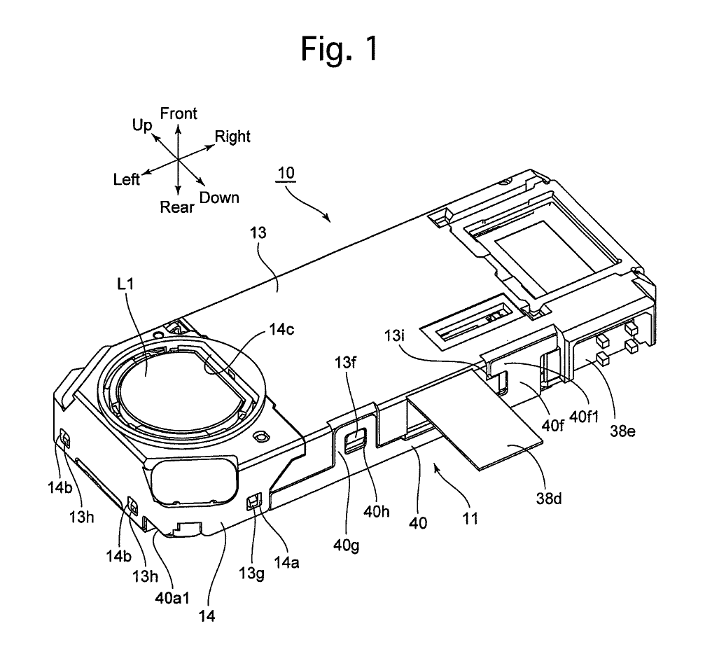

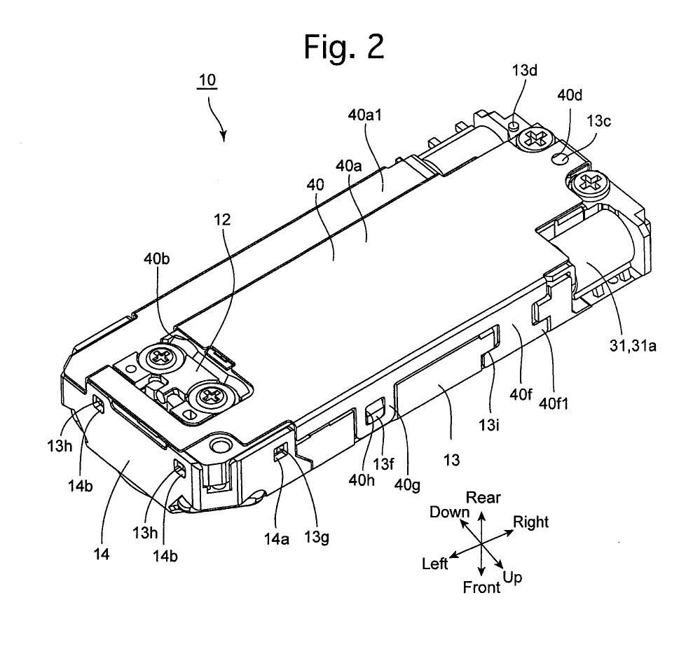

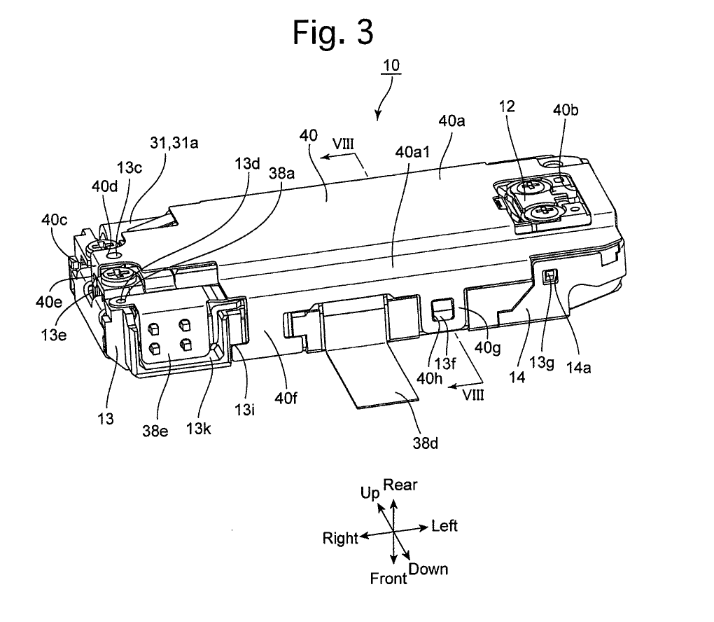

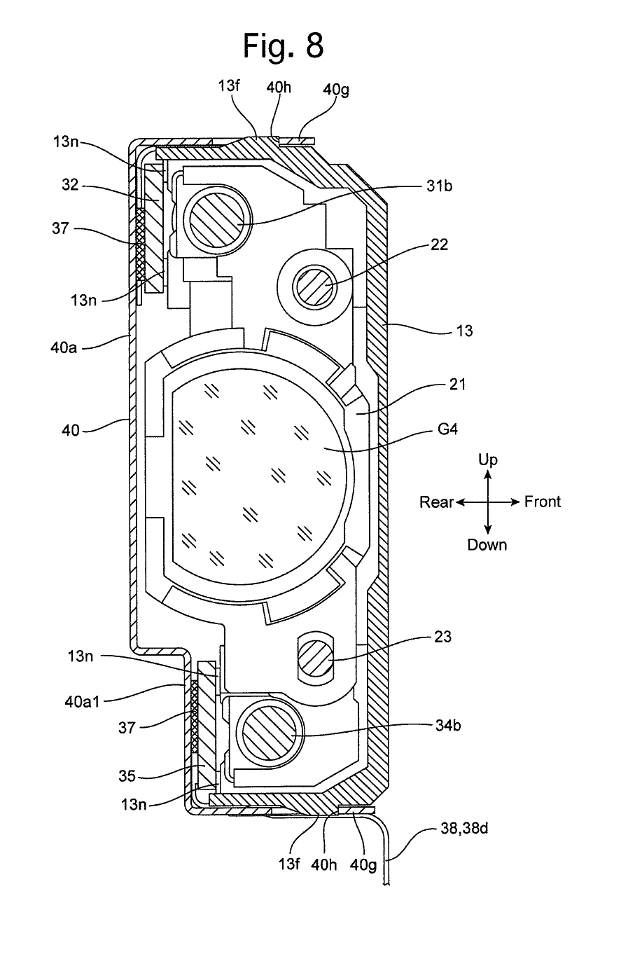

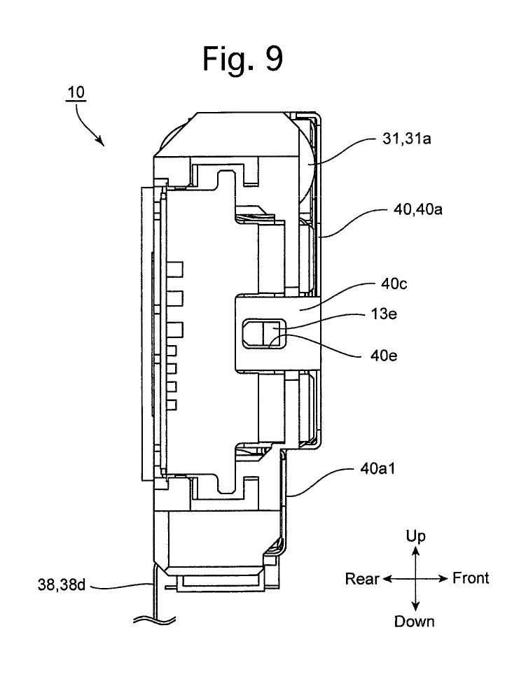

An embodiment of a bending imaging apparatus (bending imaging unit) 10 according to the present invention will be discussed below with reference to FIGS. 1 through 9. In the following descriptions, forward and rearward directions, leftward and rightward directions, and upward and downward directions are determined with reference to the directions of the double-headed arrows shown in the drawings. The present embodiment of the bending imaging apparatus 10 can be incorporated in a portable device such as a mobile terminal or a tablet computer.

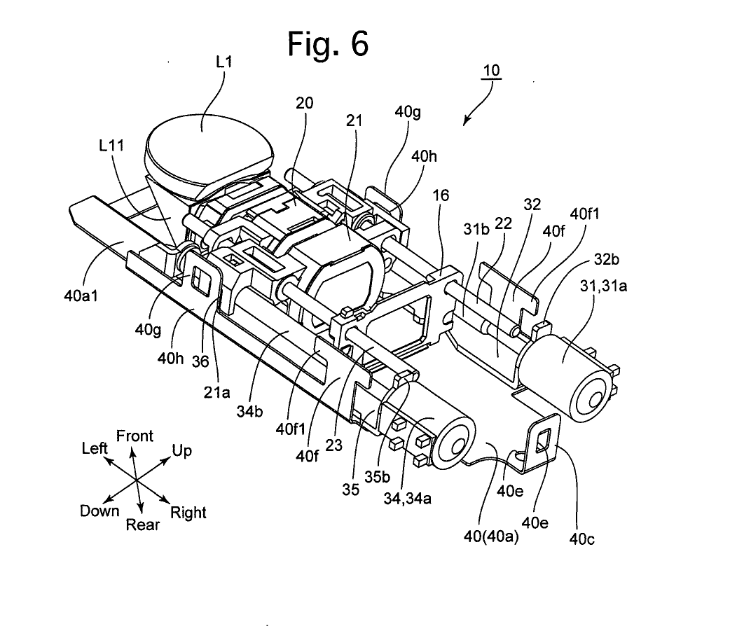

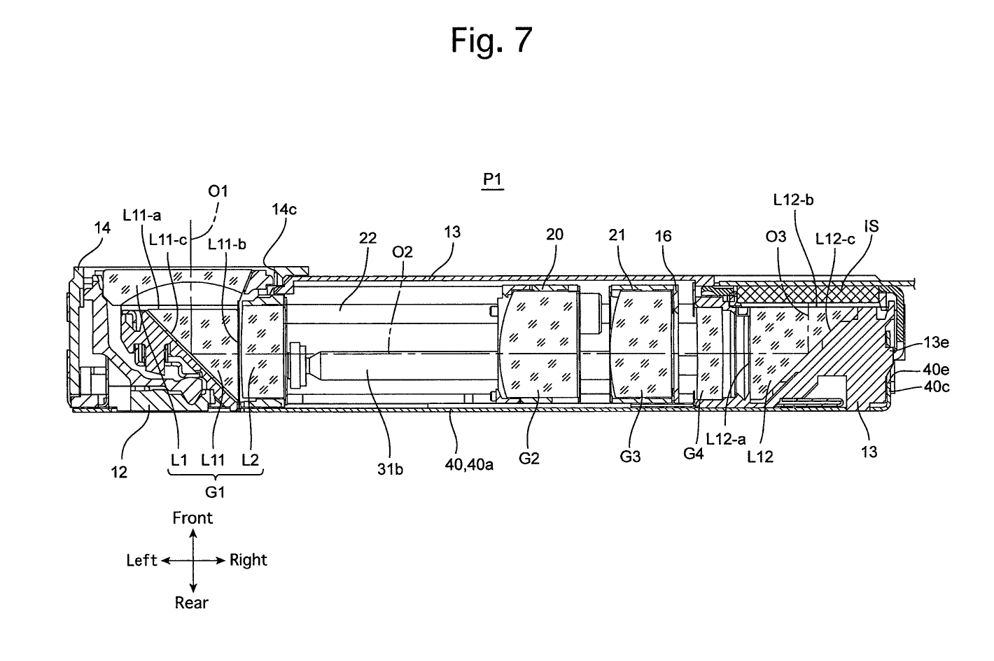

As shown in FIGS. 6 and 7, the bending imaging apparatus 10 has an imaging optical system which is provided with a first lens group (front lens group) G1, a second lens group (movable lens group) G2, a third lens group (movable lens group) G3 and a fourth lens group G4. The first lens group G1 is provided with a first prism (bending optical element) L11, and the bending imaging apparatus 10 is provided on the image side (the right-hand side with respect to FIG. 7) of the fourth lens group G4 with a second prism (bending optical element) L12. The imaging optical system of the bending imaging apparatus 10 is configured as a bending optical system which reflects (bends) an object light bundle (light reflected by an object (photographic object)) at substantially right angles at each of the first prism L11 and the second prism L12. As shown in FIG. 7, the first lens group G1 is configured of a first lens element (front lens element) L1, the first prism L11 and a second lens element L2. The first lens element L1 is positioned in front of (on the object side of) an incident surface L11-a of the first prism L11, while the second lens element L2 is positioned on the right-hand side (the image side) of an exit surface L11-b of the first prism L11. Each of the second lens group G2, the third lens group G3 and the fourth lens group G4 is a lens group which does not include a reflector element such as a prism. In the following descriptions, the optical axis of the first lens group G1 is referred to as the pre-bending optical axis O1, the optical axis which extends from the second lens group G2 to the fourth lens group G4 is referred to as the movable lens group optical axis O2, and the optical axis of the imaging optical system after being optically bent by the second prism L12 is referred to as the post-bending optical axis O3. The pre-bending optical axis O1, the movable lens group optical axis O2 and the post-bending optical axis O3 lie in a plane P1, and the pre-bending optical axis O1 and the post-bending optical axis O3 are parallel to each other. In FIG. 7, the plane P1 is parallel to the sheet of the drawing.

As shown in FIG. 7, a light bundle emanating from an object and incident on the first lens element L1 along the pre-bending optical axis O1 enters the first prism L11 through the incident surface L11-a and is reflected by a reflecting surface L11-c of the first prism L11 in a direction along the movable lens group optical axis O2 to exit from the exit surface L11-b of the first prism L11. Subsequently, the light bundle exiting from the exit surface L11-b passes through the second lens element L2 of the first lens group G1 and the second, third and fourth lens groups G2, G3 and G4, which lie on the movable lens group optical axis O2, and is incident on the second prism L12 through an incident surface L12-a thereof. Subsequently, the light bundle which is passed through the incident surface L12-a is reflected by a reflection surface L12-c of the second prism L12 in a direction along the post-bending optical axis O3 and is incident on the imaging surface of an image sensor IS to form an object image thereon.

As shown in FIGS. 1 through 4, the bending imaging apparatus 10 is provided with a housing 13, a first-lens-group unit cover 14, a motor unit 30 and a retaining cover 40. The housing 13 houses the first lens group G1, the second lens group G2, the third lens group G3, the fourth lens group G4, the second prism L12 and the image sensor IS.

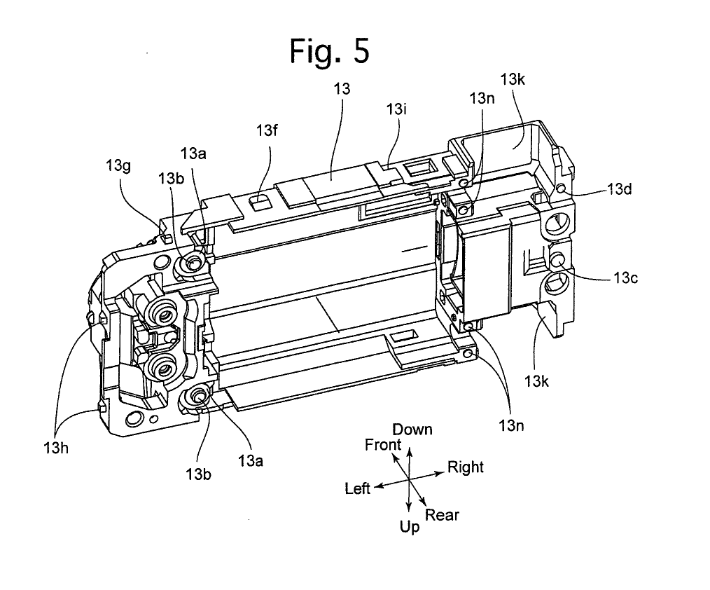

The housing 13 is a box-shaped member, the rear of which is entirely open and the front of which is partly open. The housing 13 is is elongated along the movable lens group optical axis O2 and is small in thickness (slim) in the directions of the pre-bending optical axis O1 and the post-bending optical axis O3 (see FIG. 5). The bending imaging apparatus 10 is provided, at one end (the left end) of the housing 13 in the lengthwise direction thereof, with a first lens-group unit 12 which holds the first lens group G1; and the fourth lens group G4, the second prism L12 and the imaging sensor IS are fixedly held at the other end (the right end) of the housing 13 in the lengthwise direction thereof. The image sensor IS is connected, via a flexible wiring board (not shown), to a drive control circuit of a mobile electronic device (not shown), in which the bending imaging apparatus 10 is incorporated.

The housing 13 is provided, in the rear surface of a left part of the housing 13, with an upper and lower pair of bracket-support recessed portions 13a and is provided, at the bottom of each of the pair of bracket-support recessed portions 13a, with a left bracket-support projection (positioner) 13b having the shape of a column which projects rearward. On the other hand, the housing 13 is provided, on the rear surface of a right part of the housing 13, with a rear cover-catch projection (positioner) 13c and a FPC-catch projection 13d, both of which project rearward. The FPC-catch projection 13d is positioned below the rear cover-catch projection 13c. The housing 13 is further provided on a right end surface thereof with a right retaining-cover-catch projection 13e. The housing 13 is further provided on each of top and bottom surfaces thereof with a side cover-catch projection 13f and a first-lens-group-unit cover-catch projection 13g. The housing 13 is further provided on a left end surface thereof with an upper and lower pair of first-lens-group-unit cover-catch projections 13h. The housing 13 is further provided on each of top and bottom surfaces thereof with a retaining-cover engaging recess 13i. The housing 13 is further provided on each of the top and bottom sides of the right end of the housing 13 with a motor housing recess 13k. The housing 13 is provided in the upper and lower motor housing recesses 13k with upper and lower engaging grooves 13m in which upper and lower motor support lugs (motor support portions) 32b and 35b which project from a second-lens-group drive motor support bracket 32 and a third-lens-group drive motor support bracket 35 are engaged, respectively. The housing 13 is provided, in a wall thereof on the immediate left side of the upper motor housing recess 13k, with an insertion groove in which a lead screw 31b extending from a second-lens-group drive motor 31 is inserted, and is further provided, at positions on two rear end surfaces of the aforementioned wall on the vertically opposite sides of the aforementioned insertion groove (i.e., on the vertically opposite sides of the lead screw 31b), with two motor bracket receiving protrusions 13n, respectively, and the housing 13 is provided, in a wall thereof on the immediate left side of the lower motor housing recess 13k, with an insertion groove in which a lead screw 34b extending from a third-lens-group drive motor 34 is inserted, and is further provided, at positions on two rear end surfaces of the aforementioned wall on the vertically opposite sides of the aforementioned insertion groove (i.e., on the vertically opposite sides of the lead screw 34b), with two motor bracket receiving protrusions 13n, respectively. Although each motor bracket receiving protrusion 13n can be formed integrally with the housing 13, each motor bracket receiving protrusion 13n can also be made of an elastic or low-repulsive material such as sponge as a separate member from the housing 13 and be fixed to the housing 13.

As shown in FIGS. 1 through 4, the bending imaging apparatus 10 is provided with a first-lens-group unit cover 14 which is fitted on a left portion of the housing 13. The first-lens-group unit cover 14 is provided in each of the upper and lower walls thereof with an engaging hole 14a in which the associated first-lens-group-unit cover-catch projection 13g of the housing 13 is engaged, and the first-lens-group unit cover 14 is provided in the left wall thereof with two (upper and lower) engaging holes 14b in which the upper and lower pair of first-lens-group-unit cover-catch projections 13h are engaged, respectively. The first-lens-group unit cover 14 remains fitted on the housing 13 by engagement of each first-lens-group-unit cover-catch projection 13h in the associated engaging hole 14b of the first-lens-group unit cover 14, respectively, and engagement of each first-lens-group-unit cover-catch projection 13g in the associated engaging hole 14a. In addition, the first-lens-group unit cover 14 is provided on a front surface thereof with a lens exposing opening 14c, through which the first lens group L1 is exposed toward the front of the bending imaging apparatus 10 (see FIG. 1).

The bending imaging apparatus 10 is provided, in the housing 13, with an upper and lower pair of rods 22 and 23 parallel to the movable lens group optical axis O2. Both ends (the left and right ends) of each rod 22 and 23 are fixed inside of the housing 13. As shown in FIGS. 6, etc., the second lens group G2 and the third lens group G3 are held by a second lens group frame 20 and a third lens group frame 21, respectively, which are supported to be movable along the movable lens group optical axis O2 by the pair of rods 22 and 23. Each of the second lens group frame 20 and the third lens group frame 21 is provided with an upper and lower pair of through-holes which are slidably fitted on the pair of rods 22 and 23, respectively.

The motor unit 30 is provided with the second lens group drive motor 31, the second-lens-group drive motor support bracket 32, a nut 33, the third-lens-group drive motor 34, the third-lens-group drive motor support bracket 35, a nut 36, cushioning members (elastic material) 37 and a flexible printed wiring board 38.

The second lens group drive motor 31 is integrally provided with a motor body 31a and a lead screw 31b which projects leftward from the motor body 31a. The second lens group drive motor 31 is rotatable on the axis of the lead screw 31b that is parallel to the movable lens group optical axis O2. The female screw hole formed through the nut 33 is screw-engaged with the lead screw 31b of the second lens group drive motor 31.

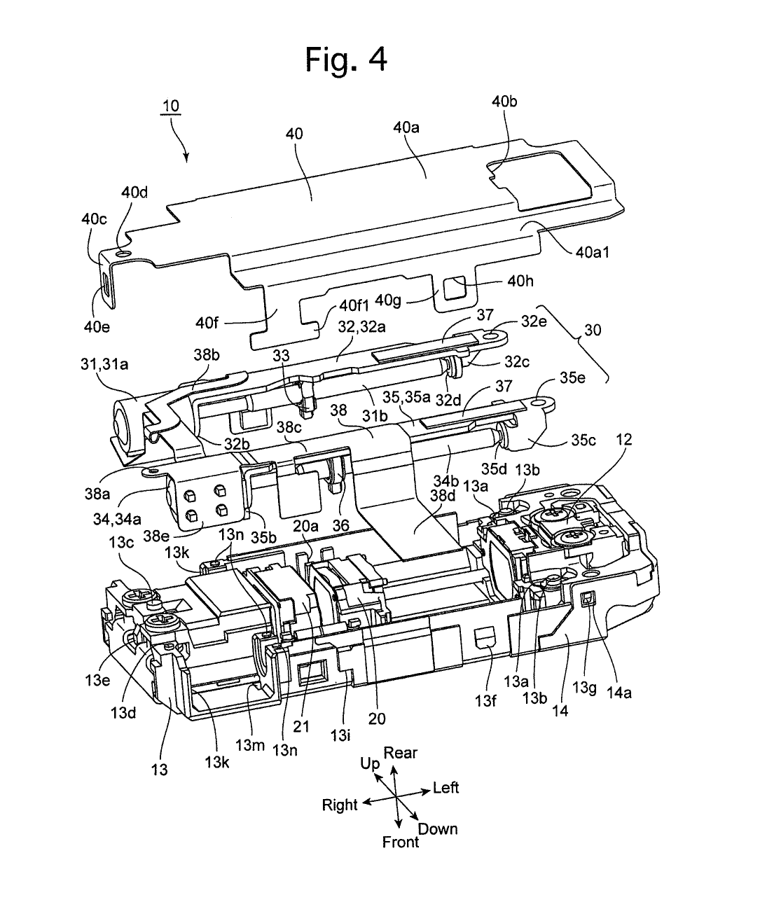

The second-lens-group drive motor support bracket (motor support bracket) 32 is formed from a metal plate by press-molding and is generally in the shape of a plate extending in the leftward and rightward directions. The second-lens-group drive motor support bracket 32 is provided with a main body (planar portion) 32a, the aforementioned motor-body support lug (motor support portion) 32b and a screw support lug (screw support portion) 32c (see FIG. 4). The main body 32a is planar in shape in directions orthogonal to the forward and rearward directions, the motor-body support lug 32b extends forward from the right end of the main body 32a, and the screw support lug 32c extends forward from a portion of the lower edge of the main body 32a in the vicinity of the left end thereof. The motor-body support lug 32b is provided with a circular through-hole through which the lead screw 31b extends, parallel to the movable lens group optical axis O2. The right end of the screw support lug 32c (the end of the screw support lug 32c on the second-lens-group drive motor 31 side) is formed from a plate-like portion lying in a plane orthogonal to the leftward and rightward directions, a circular though-hole coaxial with the circular through-hole of the motor-body support lug 32b is formed through this plate-like portion, and a bearing 32d is fitted into this circular through-hole. The main body 32a is provided at the left end thereof with an engaging hole (through-hole) 32e, which is engageable with the associated (upper) left bracket-support projection 13b of the housing 13. One of the aforementioned cushioning members 37 that is made of an elastic material is adhered to a rear surface of the main body 32a (see FIG. 4).

The second-lens-group drive motor 31, the lead screw 31b of which is screw-engaged with the nut 33, is fixedly mounted to the second-lens-group drive motor support bracket 32. Specifically, with the lead screw 31b positioned immediately in front of the main body 32a through the aforementioned circular through-hole of the motor body support lug 32b, the left end of the lead screw 31b is rotatably supported by the bearing 32d that is fitted into the screw support lug 32c, and the left side of the motor 31a is fixed to the right side of the motor body support lug 32b.

The third-lens-group drive motor 34 is identical in specification to the second-lens-group drive motor 31 and is provided with a motor body 34a and a lead screw 34b which correspond to the motor body 31a and the lead screw 31b, respectively.

A nut 36 identical in specification to the nut 33 is screw-engaged with the lead screw 34b of the third-lens-group drive motor 34.

As shown in FIG. 4, etc., the third-lens-group drive motor support bracket (motor support bracket) 35 is formed from a material that is identical to that of the second-lens-group drive motor support bracket 32, and the third-lens-group drive motor support bracket 35 and the second-lens-group drive motor support bracket 32 are substantially symmetrical in shape in the vertical direction. Namely, the third-lens-group drive motor support bracket 35 is provided with a main body (planar portion) 35a, the aforementioned motor-body support lug (motor support portion) 35b, a screw support lug (screw support portion) 35c, a bearing 35d, and an engaging hole (through-hole) 35e which correspond to the main body 32a, the motor-body support lug 32b, the screw support lug 32c, the bearing 32d, and the engaging hole 32e of the second-lens-group drive motor support bracket 32, respectively. The other of the aforementioned cushioning members 37 is adhered to a rear surface of the main body 35a (see FIG. 4). The third-lens-group drive motor 34, the lead screw 34b of which is screw-engaged with the nut 36, is fixedly mounted to the third-lens-group drive motor support bracket 35 in a fixing manner similar to that in which the second-lens-group drive motor 31 (the nut 33) is fixed to the second-lens-group drive motor support bracket 32.

The flexible printed wiring board 38 is a wiring member which connects a power supply and a control circuit, which are provided outside the bending imaging apparatus 10, to the second-lens-group drive motor 31 and the third-lens-group drive motor 34. The flexible printed wiring board 38 is routed along the second-lens-group drive motor support bracket 32 and the third-lens-group drive motor support bracket 35, and terminals of the motor bodies 31a and 34a are connected to a circuit pattern printed on the flexible printed wiring board 38. The flexible printed wiring board 38 is provided, in the vicinity of a portion thereof which is connected to the motor body 34a, with a mounting hole 38a. The flexible printed wiring board 38 is provided with a portion 38b which lies on a rear surface of the main body 32a of the second-lens-group drive motor support bracket 32, a portion 38c which lies on a rear surface of the main body 35a of the third-lens-group drive motor support bracket 35, a routing portion 38d which is routed from the bending imaging apparatus 10 to the aforementioned power supply and control circuit, and a terminal portion 38e which is fixed to the motor bodies 31a and 34a and through which the terminals of the second lens group drive motor 31 and the terminals of the third lens group drive motor 34 are exposed outwardly from the upper and lower motor housing recesses 13k, respectively.

The motor unit 30 that has the above described structure is installed in the housing 13 from behind while the motor body 31a and the motor body 34a are housed in the upper and lower motor housing recesses 13k, respectively, and while the motor body support lug 32b and the motor-body support lug 35b are being fitted into the upper and lower engaging grooves 13m, respectively. The upper and lower left bracket-support projections 13b of the housing 13 are engaged in the engaging holes 32e and 35e, respectively, while the left end of the main body 32a of the second-lens-group drive motor support bracket 32 and the left end of the main body 35a of the third-lens-group drive motor support bracket 35 are engaged in the upper and lower pair of bracket-support recessed portions 13a, respectively. In addition, the FPC-catch projection 13d of the housing 13 is engaged in the mounting hole 38a of the flexible printed wiring board 38. The second-lens-group drive motor support bracket 32 is positioned and supported with respect to the housing 13 in the forward and rearward directions by the abutment of both the left and right ends thereof against the upper bracket-support recessed portion 13a and the associated two motor bracket receiving protrusions 13n, and the third-lens-group drive motor support bracket 35 is positioned and supported with respect to the housing 13 in the forward and rearward directions by the abutment of both the left and right ends thereof against the lower bracket-support recessed portion 13a and the associated two motor bracket receiving protrusions 13n.

The nut 33 is engaged in a nut-engaging recessed portion 20a (see FIG. 4) formed in the second lens group frame 20, and the nut 36 is engaged in a nut-engaging recessed portion 21a (see FIG. 6) formed in the third lens group frame 21. Therefore, the nut 33 and the second lens group frame 20 integrally move (with each other) along the movable lens group optical axis O2, and the nut 36 and the third lens group frame 21 integrally move (with each other) along the movable lens group optical axis O2. As viewed in the forward or rearward direction, the second lens group frame 20, the third lens group frame 21 and a light shield frame 16 are positioned between the second-lens-group drive motor support bracket 32 and the third-lens-group drive motor support bracket 35. In addition, the second lens group frame 20, the third lens group frame 21 and the light shield frame 16 are partly positioned in a plane in which the main body 32a and the main body 35a lie.

The retaining cover 40 is a press-molded product made of a resilient metal plate and is provided with a planar main body portion 40a and a stepped portion 40a1. The planar main body portion 40a lies in a plane orthogonal to the forward and rearward directions. The stepped portion 40a1 is formed at a different position from the planar main body portion 40a in the forward and rearward direction and extends in the leftward and rightward directions along the planar main body portion 40a. The retaining cover 40 is further provided with a first engaging lug 40c, two (upper and lower) second engaging lugs 40f and two (upper and lower) third engaging lugs 40g. The first engaging lug 40c projects (bends) forward from the right edge of the planar main body portion 40a. Each of the upper second engaging lug 40f and the upper third engaging lug 40g projects forward from an edge (upper edge) of the planar main body portion 40a, and each of the lower second engaging lug 40f and the lower third engaging lug 40g projects forward from an edge (lower edge) of the stepped portion 40a1. The planar main body portion 40a is provided in the vicinity of the left end thereof with an exposing hole 40b, through which the first lens-group unit 12 is exposed rearwardly. The planar main body portion 40a is provided in the vicinity of the right end thereof with a circular engaging hole 40d. The first engaging lug 40c is provided with a rectangular engaging hole 40e, each third engaging lug 40g is provided with a square engaging hole 40h, and each second engaging lug 40f is provided at the end thereof with an elongated engaging protrusion 40f1 which is elongated in the leftward and rightward directions so that each second engaging lug 40f has the shape of a letter T.

The retaining cover 40 is fixedly mounted to the housing 13 by engaging the circular engaging hole 40d of the planar main body portion 40a with the rear cover-catch projection 13c of the housing 13, engaging the rectangular engaging hole 40e of the first engaging lug 40c with the right retaining-cover-catch projection 13e, engaging the square engaging hole 40h of each third engaging lug 40g with the associated side cover-catch projection 13f, and engaging the elongated engaging portion 40f1 of each second engaging lug 40f with the retaining-cover engaging recess 13i while fitting the planar main body portion 40a and the stepped portion 40a1 onto the rear surfaces of the housing 13 and the motor unit 30 from the rear.

Upon the retaining cover 40 being mounted onto the housing 13, the front of the planar main body portion 40a presses the cushioning member 37 provided on the second-lens-group drive motor support bracket 32 from the rear, while the front of the stepped portion 40a1 presses the cushioning member 37 provided on the third-lens-group drive motor support bracket 35 from the rear. Namely, the motor unit 30 (which includes the second lens group drive motor 31, the second-lens-group drive motor support bracket 32, the third-lens-group drive motor 34 and the third-lens-group drive motor support bracket 35) is sandwiched between the housing 13 and the retaining cover 40 in the forward and rearward directions, thus being positioned with respect to the housing 13 in the forward and rearward directions. In addition, the rear end of the first lens-group unit 12 is exposed through the exposing hole 40b of the retaining cover 40.

The second-lens-group drive motor support bracket 32 and the third-lens-group drive motor support bracket 35 are pressed against the housing 13 and held by the retaining cover 40 with the cushioning members 37 compressed, thus being held in a fixed state with no play between the housing 13 and each of the second-lens-group drive motor support bracket 32 and the third-lens-group drive motor support bracket 35. Transmission of vibrations of the second lens group drive motor 31 and the third-lens-group drive motor 34 to the retaining cover 40 are dampened by the cushioning members 37, and therefore, vibrations of the second lens group drive motor 31 and the third-lens-group drive motor 34 themselves are also dampened. It is desirable for the cushioning members 37 to be made of an elastic material or a material which is high in vibration damping rate such as a rubber sponge.

The retaining cover 40 retains portions 38b and 38c of the flexible printed wiring board 38 against the second-lens-group drive motor support bracket 32 and the third-lens-group drive motor support bracket 35, respectively, so that the portion 38b is tightly held between the retaining cover 40 and the second-lens-group drive motor support bracket 32 and so that the portion 38c is held between the retaining cover 40 and the third-lens-group drive motor support bracket 35.

The rear cover-catch projection 13c, the right retaining-cover-catch projection 13e, the side cover-catch projections 13f and the retaining-cover engaging recesses 13i of the housing 13, the cushioning members 37, the first engaging lug 40c, the second engaging lugs 40f and the third engaging lugs 40g constitute a fixer which fixes the retaining cover 40 to the housing 13 with a repulsive force generated to act between the planar main body portion 40a and the second-lens-group drive motor support bracket 32, with a repulsive force generated to act between the stepped portion 40a1 and the third-lens-group drive motor support bracket 35 and with each of the second-lens-group drive motor support bracket 32 and the third-lens-group drive motor support bracket 35 pressed against the housing 13.

Making battery power of the aforementioned mobile electronic device capable of being supplied to the second lens group drive motor 31 and the third-lens-group drive motor 34 via the aforementioned drive control circuit and the flexible printed wiring board 38 of the bending imaging apparatus 10 by connecting the flexible printed wiring board 38 to the aforementioned drive control circuit enables each of the second lens group drive motor 31 and the third-lens-group drive motor 34 to operate. In addition, the imaging optical system performs a zooming operation and a focusing operation by moving the second lens group frame 20 (the second lens group G2) and the third lens group frame 21 (the third lens group G3) independently of each other along the rods 22 and 23 using the second-lens-group drive motor 31 and the third-lens-group drive motor 34, which makes it possible to photograph an object image in a zoomed and focused state.

According to the above described embodiment of the bending imaging apparatus, since the retaining cover 40 is fixed onto the housing 13 with a repulsive force generated to act between the planar main body portion 40a and the second-lens-group drive motor support bracket 32, with a repulsive force generated to act between the stepped portion 40a1 and the third-lens-group drive motor support bracket 35, and with each of the second-lens-group drive motor support bracket 32 and the third-lens-group drive motor support bracket 35 pressed against the housing 13, the possibility of the housing 13 (which supports the imaging optical system that includes the first lens group G1, the movable lens groups (the second lens group G2 and the third lens group G3), the first prism L11 and the second prism L12) being distorted is small, which makes it possible to achieve the bending imaging apparatus 10 that is capable of securing the linearity of the optical axis (consisting of the optical axes O1, O2 and O3) of the imaging optical system.

Although the present invention has been applied to the above described embodiment of the bending imaging apparatus in which the ends of the lead screws 31b and 34b are positioned on the first prism L11 side and in which the second lens group drive motor 31 and the third-lens-group drive motor 34 are positioned on the second prism L12 side, an embodiment of the bending imaging apparatus in which the ends of the lead screws 31b and 34b are positioned on the second prism L12 side and in which the second lens group drive motor 31 and the third-lens-group drive motor 34 are positioned on the first prism L11 side is also possible.

Although the above described embodiment of the bending imaging apparatus is provided with the first prism L11 and the second prism L12, the present invention is also applicable to a type of bending imaging apparatus which is provided with a bending optical element (e.g., a prism corresponding to the first prism 11 or the second prism L12) only at one end of an optical axis corresponding to the movable lens group optical axis O2 (i.e., with no bending optical element provided at the other end of the movable lens group optical axis).

Although three lens groups, i.e., the second lens group G2, the third lens group G3 and the fourth lens group G4 are arranged on the movable lens group optical axis O2 in the imaging optical system of the above illustrated embodiment of the bending imaging apparatus, the present invention can also be applied to an imaging optical system in which less than or more than three lens groups are arranged on an optical axis corresponding to the movable lens group optical axis O2.

Additionally, in the first lens group G1, it is possible to change the number of lens elements arranged in front of the incident surface L11-a of the first prism L11 on the pre-bending optical axis O1 and the number of lens elements arranged on the right-hand side of the exit surface L11-b of the first prism L11 on the movable lens group optical axis O2.

Additionally, although the imaging optical system of the above illustrated embodiment of the bending imaging apparatus 10 is a zoom lens (variable power optical system) which performs a zooming operation (power varying operation) by moving the second lens group G2 and the third lens group G3 along the movable lens group optical axis O2, the present invention is also applicable to a bending imaging apparatus which incorporates an imaging optical system having no power varying capability. For instance, it is possible to modify the bending imaging apparatus 10 such that the second lens group G2 and the third lens group G3 do not move for a zooming operation and that the second lens group G2 or the third lens group G3 moves solely for a focusing operation.

Although the incident surface L11-a of the first prism L11 in the above illustrated embodiment of the bending imaging apparatus 10 is in the shape of a laterally elongated rectangle, the present invention can also be applied to a type of bending imaging apparatus (imaging optical system) having a first prism (which corresponds to the first prism L11) having a different shaped incident surface, such as a square or a trapezoid.

In the above illustrated embodiment of the bending imaging apparatus, although the cushioning members 37 are used (included) in the aforementioned fixer, which is for fixing the second-lens-group drive motor support bracket 32 and the third-lens-group drive motor support bracket 35 to the housing 13 by pressing the second-lens-group drive motor support bracket 32 and the third-lens-group drive motor support bracket 35 against the housing 13, the present invention is not limited to this particular embodiment. For instance, it is possible to provide the retaining cover 40 with at least one protrusion that presses the second-lens-group drive motor support bracket 32 and the third-lens-group drive motor support bracket 35 against the housing 13 to thereby fix the second-lens-group drive motor support bracket 32 and the third-lens-group drive motor support bracket 35 to the housing 13 with no play between the housing 13 and each of the second-lens-group drive motor support bracket 32 and the third-lens-group drive motor support bracket 35.

Furthermore, in the illustrated embodiment, although no screws are used to mount the second-lens-group drive motor support bracket 32 and the third-lens-group drive motor support bracket 35 to the housing 13, mounting screws may additionally be used together with the above-described fixer (the rear cover-catch projection 13c, the right retaining-cover-catch projection 13e, the side cover-catch projections 13f and the retaining-cover engaging recesses 13i of the housing 13, the cushioning members 37, the first engaging lug 40c, the second engaging lugs 40f and the third engaging lugs 40g) providing that the mounting screws do not deform the housing 13. Obvious changes may be made in the specific embodiment of the present invention described herein, such modifications being within the spirit and scope of the invention claimed. It is indicated that all matter contained herein is illustrative and does not limit the scope of the present invention.

What is claimed is:

1. A bending imaging apparatus comprising:
a movable lens group which is movable along an optical axis thereof;
a motor which drives said movable lens group and includes a lead screw extending parallel to said optical axis;
a bending optical element arranged at at least one end of said optical axis to bend an object-emanating light bundle;
a housing which supports said movable lens group and said bending optical element;
a motor support bracket which includes a motor support portion that supports said motor, a screw support portion that supports an end of said lead screw, and a planar portion that is positioned between said motor support portion and said screw support portion and extends alongside said housing;
a cover member which includes a planar portion facing said planar portion of said motor support bracket; and
a fixer which fixes said cover member to said housing with a repulsive force generated to act between said planar portion of said motor support bracket and said planar portion of said cover member and with said motor support bracket pressed against said housing.

2. The bending imaging apparatus according to claim 1, wherein said fixer comprises an elastic member which is sandwiched and fixed between said planar portion of said motor support bracket and said planar portion of said cover member.

3. The bending imaging apparatus according to claim 1, further comprising a positioner which is positioned between said housing and said motor support bracket to position said housing and said motor support bracket with respect to each other.

4. The bending imaging apparatus according to claim 1, wherein said cover member is made of a resilient material, and
wherein said fixer comprises:
a plurality of engaging lugs formed on said cover member to protrude therefrom; and
a plurality of engaging portions formed on said housing to be engaged with said plurality of engaging lugs.

5. The bending imaging apparatus according to claim 4, wherein an engaging hole is formed in at least one of said engaging lugs, and
wherein at least one of said engaging portions of said housing comprises an engaging projection which is engaged in said engaging hole of said at least one of said engaging lugs.

6. The bending imaging apparatus according to claim 4, wherein at least one of said plurality of engaging lugs comprises an engaging protrusion, and
wherein at least one of said engaging portions includes an engaging recessed portion in which said engaging protrusion is engaged, said engaging recessed portion being formed on said housing.

7. The bending imaging apparatus according to claim 1, wherein said fixer comprises a plurality of engaging portions which are integrally formed with said housing to be engageable with said cover member.

8. The bending imaging apparatus according to claim 1, wherein said positioner is integrally formed with said housing.
